(19) United States
(12) Patent Application Publication
(10) Pub. No.: US 2004/0017681 A1
(43) Pub. Date: Jan. 29, 2004

(54) Cabinet lamp

(76) Inventor: Jack Lee, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/206,106

(22) Filed: Jul. 29, 2002

(51) Int. Cl. F21V 33/00

(52) U.S. Cl. 362/133; 362/368; 362/398

(57) ABSTRACT

An improved cabinet lamp has a switch located on one side of a lamp holder to facilitate user operation. The cabinet lamp consists of an upper lid and a lamp holder. The lamp holder has a pushbutton switch located on one side and an anchor lug located on the other side for engaging with a screw to fasten the lamp holder to a top surface of the cabinet. The cabinet lamp may be installed easily by users without removing the upper lid. The plug does not need to be removed or inserted frequently when in use, thus has a longer life span.

### BACKGROUND OF THE INVENTION

1. Field of the Invention

The invention relates to an improved cabinet lamp and particularly a cabinet lamp that has a built-in pushbutton switch and is convenient for user self installation.

2. Description of the Prior Art

Conventional cabinets or chests used in households generally have a cabinet lamp 2 installed on the top surface 1 for decorative or lighting purpose (referring to FIGS. 1 and 2). The cabinet lamp mainly consists of an upper lid 21 and a lamp holder 22. The lamp holder 22 is fastened to the top surface 1 of the cabinet by means of screws 23. While such a design can serve the purpose of decoration or lighting, it has the following disadvantages:

1. When the cabinet lamp 2 is part of the interior design of the house and is installed on the top surface 1 of the cabinet, the power cored 24 has to be connected to the existing power supply in the house and a separate switch has to be installed to control the cabinet lamp. The installation involves a lot of work and often is beyond the ability of ordinary people to do by themselves.

2. In the event that the cabinet is a finished goods with the cabinet lamp 2 installed that consumers buy for ready use, the attached power cord 24 usually connects to a plug (not shown in the drawings) to enable users to insert into an existing power supply receptacle when in use. The plug has to be inserted into the receptacle every time the cabinet lamp 2 is used. It is not convenient. Moreover, inserting and removing the plug repeatedly reduces the useful life of the plug and the receptacle.

3. When consumers want to install or change the cabinet lamp 2 by themselves, they have to remove the upper lid 21 and fasten the screws 23 to the top surface 1 of the cabinet. Installation is not easy and is prone to damage the cabinet.

### SUMMARY OF THE INVENTION

In view of aforesaid disadvantages, the primary object of the invention is to provide an improved cabinet lamp that has a built-in switch located on one side of the lamp holder so that it can be used readily without the need of installing an additional switch or using a plug to control on and off of the cabinet lamp.

Another object of the invention is to provide an improved cabinet lamp that is safely designed and constructed to prevent users from burning by touching the heated lamp bulb.

Yet another object of the invention is to provide an improved cabinet lamp that enables users to install easily by themselves without damaging the cabinet.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional cabinet lamp.

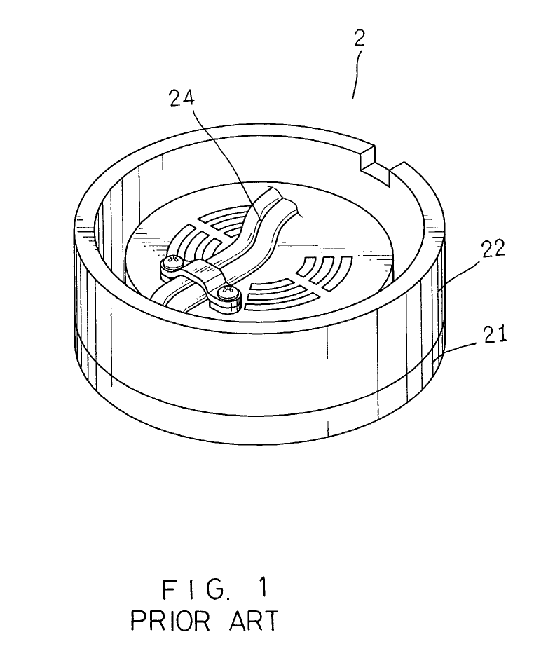

FIG. 2 is a cross section of a conventional cabinet lamp.

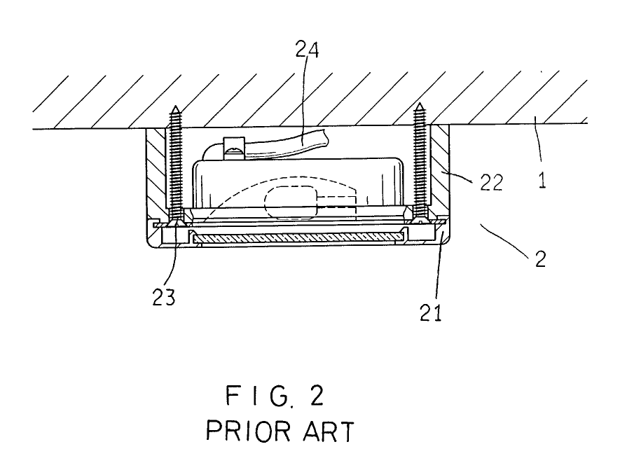

FIG. 3 is a perspective view of the invention, partly exploded.

FIG. 4 is a cross section of the invention.

FIG. 5 is a schematic top view of an embodiment of the invention.

### DESCRIPTION OF THE PREFERRED EMBODIMENT

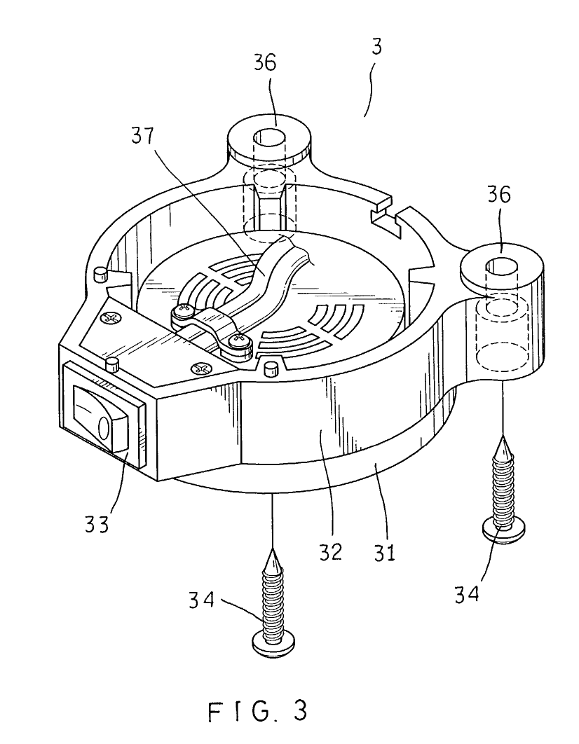

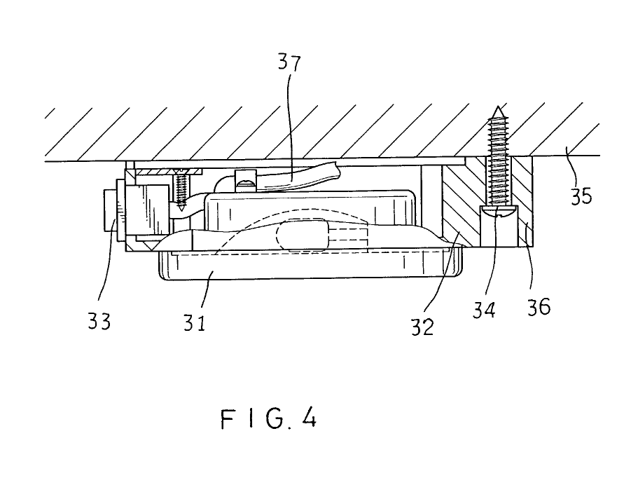

Referring to FIGS. 3 and 4, the cabinet lamp 3 of the invention mainly includes an upper lid 31 and a lamp holder 32. The upper lid 31 is fastened to the lamp holder 32. The lamp holder 32 has a pushbutton switch 33 located on one side and anchor lugs 36 located on other side for engaging with screws 34 to fasten the lamp holder 32 to the top surface 35 of a cabinet. Inside the lamp holder 32, there is a power cord 37 connecting to a plug (not shown in the drawings).

When to install the cabinet lamp 3, fasten the screws 34 to the top surface 35 of the cabinet through the anchor lugs 36, then fasten the upper lid 31 to the lamp holder. Then insert the plug of the power cord 37 to the receptacle of the power supply. With the built-in pushbutton switch 33, there is no need to insert or remove the plug when in use, thus the life span of the plug can be increased. In addition, with the pushbutton switch 33 located on one side of the lamp holder 32, users do not have to touch the heated lamp bulb when to turn off the cabinet lamp 3, therefore can be free from hurting by burning.

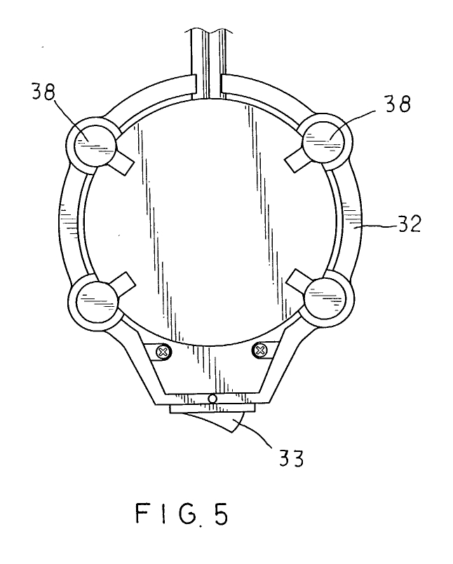

Refer to FIG. 5 for an embodiment of the invention. On the back side of the lamp holder 32, there are a plurality of magnetic elements 38 embedded thereon for attaching to the top surface 35 of the cabinet that made from metal. Then there is no need to use screws to fasten the cabinet lamp 3.

While the preferred embodiments of the invention have been set forth for the purpose of disclosure, modifications of the disclosed embodiments of the invention as well as other embodiment thereof may occur to those skilled in the art. Accordingly, the appended claims are intended to cover all embodiments which do not depart from the spirit and scope of the invention.

I claim:

1. An improved cabinet lamp comprising a lamp holder and an upper lid fastened to the lamp holder, wherein the lamp holder has a pushbutton switch located on one side thereof and an anchor lug located on other side thereof for engaging with a screw to fasten the lamp holder to a top surface of a cabinet.

2. The improved cabinet lamp of claim 1, wherein the lamp holder has a back side embedded with a plurality of magnetic elements for attaching to a metal top surface of the cabinet,
